(19) United States
(12) Patent Application Publication
(10) Pub. No.: US 2021/0161291 A1
(43) Pub. Date: Jun. 3, 2021

(54) SYSTEM FOR MOBILE, MODULAR FURNITURE STORAGE AND DEPLOYMENT

(71) Applicants: Kloe Ng, Cambridge, MA (US); Yu Qian Ang, Cambridge, MA (US)

(72) Inventors: Kloe Ng, Cambridge, MA (US); Yu Qian Ang, Cambridge, MA (US)

(21) Appl. No.: 17/104,452

(22) Filed: Nov. 25, 2020

Related U.S. Application Data
(60) Provisional application No. 62/942,708, filed on Dec. 2, 2019.

(51) Int. Cl. A47B 47/04; A47B 47/00; A47B 87/02; F16B 5/02

(52) U.S. Cl. CPC A47B 47/042; A47B 47/0091; F16B 12/26; A47B 87/02; F16B 5/0225; A47B 47/047

(57) ABSTRACT

In an aspect, a system for mobile modular furniture storage and deployment, wherein the system comprises a three-dimensional form having opposite and opposing sides, a plurality of modular furniture elements each configurable from a storage mode to a deployed mode. The three-dimensional form is configured to encapsulate a modular furniture element in a storage mode. The plurality of modular furniture elements are further configured to couple to at least one other of the plurality of furniture elements and two coupled modular furniture elements form at least a portion of a side of the three-dimensional form.

### CROSS-REFERENCE TO RELATED APPLICATIONS

This application claims the benefit of priority of U.S. Provisional Patent Application Ser. No. 62/942,708, filed on Dec. 2, 2019, and titled “A SYSTEM FOR MOBILE, MODULAR FURNITURE STORAGE AND DEPLOYMENT,” which is incorporated by reference herein in its entirety.

### FIELD OF THE INVENTION

The present invention generally relates to the field of mobile, modular furniture. In particular, the present invention is directed to a system for modular furniture that may be stored as and deployed from, a single three-dimensional form.

### BACKGROUND

Classrooms may be increasingly difficult to attend, supply, run, and perhaps learn in, especially in uncertain times. Developed and underdeveloped countries alike may find pandemics, wars, natural disasters, and like catastrophes very disruptive to education, let alone the resources needed to effectively teach students in a plurality of environments. Schooling from home or other types of non-traditional settings require the tools and materials to be flexible and versatile in order to impart knowledge on those who need it most. The burgeoning of the necessity to be able to teach students in an everchanging world requires a classroom that can adapt to the needs of the students.

### SUMMARY OF THE DISCLOSURE

In an aspect, a system for mobile, modular furniture storage and deployment, wherein the system comprises a three-dimensional form having opposite and opposing sides, a plurality of modular furniture elements each configurable from a storage mode to a deployed mode. The three-dimensional form is configured to encapsulate a modular furniture element in a storage mode. The plurality of modular furniture elements are further configured to couple to at least one other of the plurality of furniture elements and two coupled modular furniture elements form at least a portion of a side of the three-dimensional form.

In another aspect, the system can further include one or more of the following features taken either alone or in combination: the three-dimensional form can be a cube, Further, the length of the cube can be one meter. A graphical user interface (GUI) that can display information associated with the plurality of modular furniture elements. The plurality of modular furniture elements can comprise a plurality of classroom furniture elements. The plurality of modular furniture elements can comprise at least one selected from a group of a table, an easel, a whiteboard, a bench, or a box. The plurality of modular furniture elements can comprise a first and second table. At least a portion of the first table and at least a portion of the second table can be configured to form a surface of the three-dimensional form when coupled. At least one modular furniture element of the plurality of modular furniture elements can be located wholly inside the three-dimensional form when stored.

In yet another aspect, an element of modular furniture may comprise a rope configured to capture a knob disposed on another element of modular furniture and mechanically couple them together. Further, modular furniture elements may comprise a rolling element configured to transport at least a portion of the three-dimensional form. A frame comprising support for a modular furniture element may be disassembled for storage in a flat shape, for further storage in a three-dimensional form or as a standalone element. Any element of modular furniture may be mechanically coupled to any other element of modular furniture. A first element of modular furniture may comprise an energy charging and storage system configured to generate a form of energy and store energy for later use. A first element of modular furniture may comprise a snap fit mechanical coupling with a second element of modular furniture.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1A is an isometric view of a three-dimensional (3D) form of a cube containing modular furniture elements, according to embodiments;

FIG. 1B is an isometric view of modular furniture elements contained within a cube, according to embodiments;

FIGS. 2A-B are isometric views of modular furniture elements and a latching system, and orthogonal projections thereof, according to embodiments;

FIG. 3 is an isometric view of the disassembly of modular furniture element for storage;

FIG. 4 is an orthogonal cutaway view of retainment mechanisms comprised by modular furniture elements;

FIGS. 5A-D are isometric representations of embodiments of a transportation system for modular furniture;

FIGS. 6A-C is an isometric view of modular furniture and orthogonal views of a modular furniture element and a rope retainment system;

FIG. 7 is a personal device electronic application that may display information on modular furniture elements and learning modules;

FIG. 8 is a block diagram illustrating an exemplary embodiment of a computer system.

The drawings are not necessarily to scale and may be illustrated by phantom lines, diagrammatic representations, and fragmentary views. In certain instances, details that are not necessary for an understanding of the embodiments or that render other details difficult to perceive may have been omitted.

### DETAILED DESCRIPTION

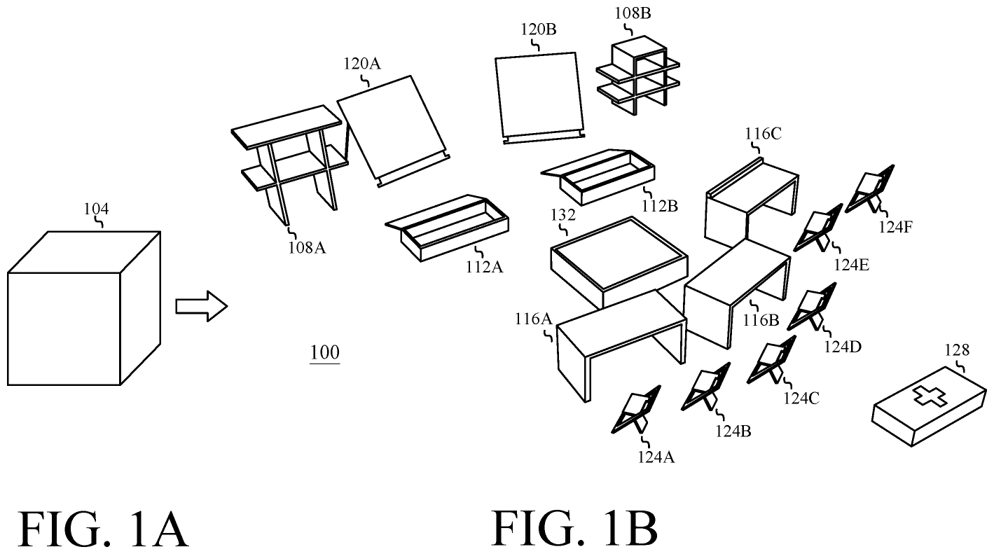

In the following description, for the purposes of explanation, numerous specific details are set forth in order to provide a thorough understanding of the present invention. It will be apparent, however, that the present invention may be practiced without these specific details. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply embodiments of the inventive concepts defined in the appended claims. Hence, specific dimensions and other physical characteristics relating to the embodiments disclosed herein are not to be considered as limiting, unless the claims expressly state otherwise.

“Furniture”, as used herein, comprises movable equipment used to make a house, office, room, building, and/or other space suitable for living or working. For example, furniture, as it relates to a classroom, may include desks, chairs, easels, stools, shelves, and the like. “Modularity”, as used herein, is the degree to which a system's components may be separated and recombined, often with the benefit of flexibility and variety in use. “Modular furniture”, therefore, as used herein, is furniture that may be mixed and matched to accomplish a specific goal, and further, may be reconfigured in shape to be stored, shipped, transported, or moved more easily. Modularity, when it comes to furniture, may also comprise the ability of individual elements of furniture to be removed and replaced with other elements of modular furniture because they may, for example, comprise a similar interface.

At a high level, aspects of the present disclosure are directed to systems for modular furniture storage and/or deployment. In an embodiment, a mobile infrastructure containing a plurality of modular furniture can be compactly packed into a three-dimensional (3D) form. This 3D form may comprise any 3D shape with any number of sides, angles, and faces. For example, the 3D form can comprise a box or cube. In embodiments, the 3D form can be opened into a livable and/or workable space can include one or more pieces of modular furniture used to make the space livable and/or workable.

With reference to FIG. 1A, an embodiment of modular furniture system 100 is presented in a three-dimensional (3D) form. Modular furniture system 100 may comprise 3D form 104, here presented as a cube or box. In embodiments, modular furniture system 100 is configured to deploy as a plurality of pieces of modular furniture. Deploying modular furniture system 100 can include unfolding, uncoupling, removing, unfastening, and/or unbuckling one or more modular furniture elements forming 3D form 104. 3D form 104 may take any 3D shape such as a pyramid, prism, box, cube, or sphere, to name a few. 3D form 104 may be formed by two or more pieces of modular furniture fitting and/or mechanically coupled together.

With reference to FIG. 1B, an embodiment of modular furniture system 100 in a deployed form is presented. 3D form 104 may comprise a plurality of elements 108A-128 each configured to be folded, disassembled in whole or in part, manipulated, and/or fit partially and/or wholly together to form at least a portion of 3D form 104. Each of the plurality of elements 108A-128 comprises a piece of modular furniture associated with a room type. A room type can include a living space such as a bedroom, kitchen, living room, dining room, bathroom, or the like; an educational space such as a classroom, theater, lecture hall, or the like; recreational space such as a gymnasium, ball room, lounge, or the like; working space such as a meeting room, board room, multipurpose room, office, or the like; medical space such as a nurse's office, emergency room, operating room, intensive care unit, first aid station, or the like; covered space of any kind such as a pavilion or gazebo, ballroom; laboratory space such as a lab, garden, test facility; or any combination thereof. For example, elements 108A-128 can be associated with a classroom and can include shelves 108A-B, learning modules 112A-B, desks 116A-C, easels 120A-B, chairs 124A-F, first-aid kit 128, and supply kit 132. The contents of, for example, learning modules 112A-B, first-aid kit 128, and supply kit 132 are discussed in greater detail below.

According to embodiments, two or more modular furniture elements 108A-128 can couple to one another to form at least a portion of 3D form 104. For example, larger modular furniture elements, when coupled together, may be disposed near the outer surfaces of 3D form 104 to form opposite and opposing sides. In embodiments, the outer surfaces of 3D form 104 can be configured to at least partially enclose one or more modular furniture elements 108A-128. Each modular furniture element 108A-128 can be configured to removably couple to at least a portion of or at least one other modular furniture element 108A-128. According to embodiments, each modular furniture element 108A-128 may have a predetermined orientation when forming a portion of 3D form 104. A predetermined orientation can include a predetermined angle, rotation, configuration, placement within 3D form 104, placement relative to another modular furniture element, or any combination thereof. Removable coupling between two or more modular furniture elements can include, for example, the use of mechanical fasteners, friction, buckles, straps, grooves, bosses, snap assemblies, rigid coupling (e.g. beam coupling), bellows coupling, bushed pin coupling, constant velocity, split-muff coupling, diaphragm coupling, disc coupling, donut coupling, elastic coupling, flexible coupling, fluid coupling, gear coupling, grid coupling, hirth joints, hydrodynamic coupling, jaw coupling, magnetic coupling, Oldham coupling, sleeve coupling, tapered shaft lock, twin spring coupling, rag joint coupling, universal joints, or any combination thereof. For example, a first modular furniture element can be removably coupled to two other modular furniture elements using snap assemblies. According to embodiments, modular furniture elements may replace like or unlike modular furniture elements forming at least a portion of 3D form 104. In other words, a first modular furniture element may form a side of undeployed 3D form 104. A second distinct modular furniture element may replace the first modular furniture element forming the same side of 3D form 104. In embodiments, any modular furniture element may be replaced with any respective modular furniture element forming at least a portion of 3D form 104. Modular furniture elements may be configured to replace any other modular furniture element within 3D form 104. Further, modular furniture elements may comprise component level elements that may be configured to be switched, replaced, reconfigured, or otherwise manipulated between one or modular furniture elements. As a non-limiting example, supports like legs may be swapped between modular furniture elements that require supports like legs.

Continuing to refer to FIG. 1B, shelves 108A-B may comprise modular shelving that includes multiple levels of flat surfaces effectively parallel to the ground. For example, each flat surface can be effectively parallel to the ground such that each flat surface is configured to support one or more components. “Components”, as used in this disclosure, comprise any object, instrument, consumable, tool, or electronic associated with a room type such as pencils, pens, computers, client devices, bandages, beakers, test tubes, lights, fans, phones, medications, food, or any combination thereof, to name a few. For example, components can include objects and instruments found in a classroom or similar setting. In embodiments, modular furniture system 100 can include one or more components associated with a room. According to embodiments, each flat surface of shelves 108A-B may comprise parallel, opposite, and opposing surfaces that may be configured to fold out or be reconfigured from a flat form (such as when undeployed) to a multilevel storage solution in deployed form. Each flat surface of shelves 108A and B, respectively, may be removable or disassembled from the shelf to be stored, stacked, and/or layered when undeployed and reassembled upon deployment. Additionally, or alternatively, shelves 108A-B may fold such that each shelf 108A and B, may comprise hinges, flaps, slots, or the like to change shape. Shelves 108A-B may each be configured to have a thickness ranging from 5 millimeters to several centimeters, in an illustrative, non-limiting embodiment. Shelves 108A-B may be configured to support significant physical loads in deployed and undeployed form. As the deployed shelf system, shelves 108A-B may be rated to hold a predetermined amount of weight or mass on each flat surface. Shelves 108A-B may comprise external supports configured to handle these loads like struts, beams, honeycombs, laminates, or other means one of ordinary skill in the art would appreciate to add strength to a physically thin and lightweight structure. In embodiments, shelves 108A-B can each comprise materials such as high-strength plastics like polypropylene, polycarbonate, polyethylene terephthalate, polyvinyl chloride (PVC), acrylonitrile butadiene styrene (ABS), high-density polyethylene (HDPE), nylon, wood, and/or polystyrene, to name a few. Materials other than plastics may comprise high-strength, low-weight solutions like aluminum and aluminum alloys including magnesium, titanium, and beryllium alloys. Shelves 108A-B may comprise fastening mechanisms and mechanical coupling systems that are configured to removably couple shelves to structural elements and/or other modular furniture elements such as bosses, channels, screws, bolts, nuts, nails, pins, dowels, rivets, and/or any combination thereof, to name a few.

Modular furniture system 100 may also comprise learning modules 112A-B. Learning modules 112A-B may each comprise classroom learning materials relating to one or more subjects such as STEAM (Science, Technology, Engineering, Art, and Mathematics), humanities, history, fine arts, music, civics, language, literature, drama, or any combination thereof, to name a few. Learning materials can include any component of modular furniture system 100 as discussed herein such as musical instruments, pens, pencils, beakers, test tubes, Bunsen burners, graduated cylinders, clamps, forceps, magnifying glasses, or any combination thereof. In embodiments, learning modules 112A-B may each comprise any 3D form as discussed herein. For example, learning modules 112A-B may each comprise a respective box having sets of opposite and opposing sides. In embodiments, the 3D form of each learning module 112A-B may be configured to enclose and/or encapsulate at least a portion of one or more learning materials. For example, a learning module 112 may comprise a 3D form of a box configured to enclose a pencil, beaker, and test tube. The 3D form of learning modules 112A-B may include lids, covers, doors, and/or another undisclosed provision configured to enclose and/or encapsulate learning materials.

In embodiments, learning modules 112A-B may each be configured to be stackable with one other and/or other modular furniture elements. Learning modules 112A-B may be, as their name suggests, swappable with any other learning module that may store in 3D form 104 in a similar, the same, or entirely different arrangement. According to embodiments, learning modules 112A-B may comprise retainment such as shadowboxes, cutouts, clamps, tiedowns, slots, holes, and the like for organization of learning materials. Learning modules 112A-B may comprise modular elements that allow for replacement of constituent structural elements such as lids and walls with other modular furniture elements present in system. Learning modules 112A-B may be similarly strong and tough in both tension and compression such that when deployed and stored, loads applied parallel to and transverse to members can be supported, for example while in shelf mode and 3D form 104 mode. Learning modules 112A-B may comprise materials suitable for high-strength, low weight applications. These materials may comprise high-strength plastics like polypropylene, polycarbonate, polyethylene terephthalate, polyvinyl chloride (PVC), acrylonitrile butadiene styrene (ABS), high-density polyethylene (HDPE), nylon, and polystyrene, to name a few. Materials other than plastics may comprise high-strength, low-weight solutions like aluminum and aluminum alloys including magnesium, titanium, and beryllium alloys. Learning modules 112A-B may comprise fastening mechanisms and general mechanical coupling systems that are configured to couple easels to structural elements like bosses and channels, screws, bolts and nuts, nails, pins, dowels, rivets, and/or the like.

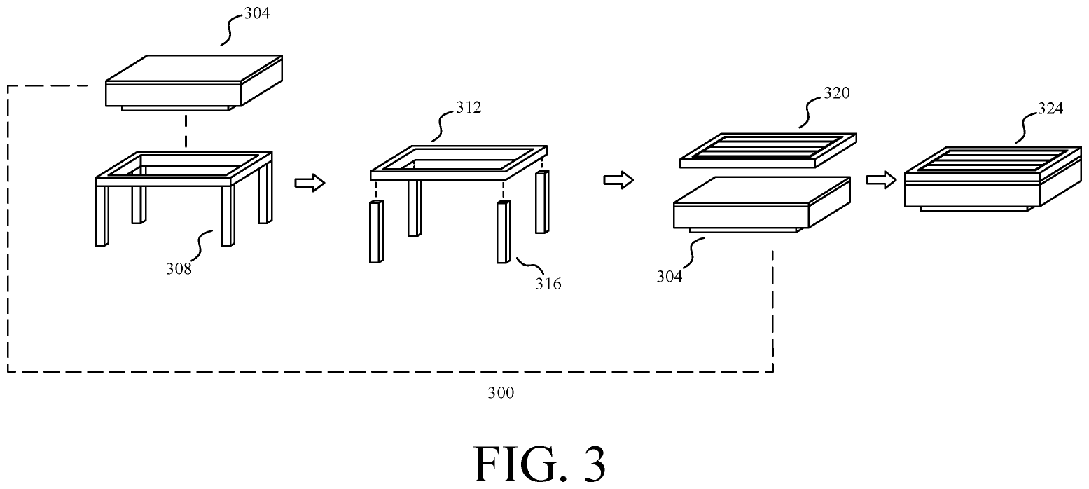

With continued reference to FIG. 1B, modular furniture elements 108A-128 can also include desks 116A-C. Desks 116A-C may be configurable in a plurality of ways or be entirely distinct in function or design from any other desk in system. In embodiments, each desk 116 may comprise tabletops, supports, and/or legs. In embodiments, tabletops may comprise a plurality of planform shapes like a square, rectangle, circle, oval, ring, or a combination thereof, to name a few. Tabletops may comprise a predetermined thickness sufficient to support loads when deployed and undeployed. Tabletops may comprise a thickness that is configurable so that it may be adjusted for a predetermined use, such that tabletop may be relatively thinner when stored than when deployed. Tabletops may be configured to change shape between deployed and undeployed form and may include, but is not limited to, folding supports like legs, trusses, pillars, rods, feet, folding mechanisms, flaps, expansion mechanisms, or a combination thereof, to name a few. According to embodiments, a desk 116 may comprise a single piece of material forming a tabletop and legs. In other embodiments, a desk 116 may comprise distinct elements and materials forming a respective tabletop and legs. As discussed in further detail below with reference to FIG. 3, desks 116 can include modular components configured to be removably coupled, swapped, and/or switched between each the desks 116A-C. For example, each desk 116 can include tabletops, legs, and/or supports configured to be swappable between desks 116.

In embodiments, each desk 116, may be configured to be collapsible and/or foldable in part or in whole. For example, a desk 116 may be configured to collapse in an accordion-style folding mechanism. As another example, a desk 116 may be configured to fold in its legs but not manipulate its tabletop at all. According to embodiments, each desk 116A-C may comprise a tabletop having opposite and opposing, effectively parallel surfaces configured to allow objects to be placed and supported on the tabletop when in deployed form. Each tabletop can comprise a two-dimensional area/surface sufficient for writing upon. Desks 116A-C may also comprise supports in a plurality of forms such as single pillar-like supports, or legs and walls of variable or adjustable heights. Desks 116A-C may comprise collapsible components for storage when undeployed within 3D form 104. These components may comprise hinges, folds, creases, disassembly points, and the like. For example, desks 116A-C may comprise table legs that are removable from their deployed configuration and capable of being reassembled in a separate and distinct storage configuration. Desks 116A-C may utilize any of the mechanical coupling methods discussed earlier in this paper alone or in combination with any undisclosed manner of coupling mechanically. Desks 116A-C may comprise materials suitable for high-strength, low-weight applications like high-strength plastics like polypropylene, polycarbonate, polyethylene terephthalate, polyvinyl chloride (PVC), acrylonitrile butadiene styrene (ABS), high-density polyethylene (HDPE), nylon, and polystyrene, to name a few. Materials other than plastics may comprise high-strength, low-weight solutions like aluminum and aluminum alloys including magnesium, titanium, and beryllium alloys.

Desks 116A-C may be configured to support significant physical loads in deployed and stored form. As the deployed desk, desks 116A-C may be rated to hold a certain amount of weight or mass on tabletop or each support system component given a certain safety margin as to not fail when used. Desks 116A-C may be similarly strong and tough in both tension and compression such that when deployed and stored, loads applied parallel to and transverse to members can be supported, for example while in shelf mode and 3D form 104 mode. Desks 116A-C may comprise external supports to assist in handling these loads like struts, beams, honeycombs, laminates, or other means one of ordinary skill in the art would appreciate to add strength to a thin and lightweight structure supporting loads in excess of its own weight, perhaps.

With continued reference to FIG. 1B, modular furniture system 100 may also comprise easels 120A-B. Easels 120A-B may be configured to display written material in order to convey information. Easels 120A-B may comprise whiteboards, chalkboards, or stands configured to be written on and display said writing. Easels 120A-B, as discussed may comprise a material suitable to be written on and erased, like dry-erase markers on whiteboards or chalk on chalkboards. Easels 120A-B may additionally, or alternatively, comprise provisions for securing in place a medium on which to write over their surface, like, for example, clips disposed on at least a portion of easel for hanging paper to be written on over the front of easel 120A-B. Easels 120A-B may comprise both paper-hanging provisions like clips and an integral writing surface like a whiteboard simultaneously, or on opposite and opposing surfaces. Easels 120A-B may comprise support elements as illustrated in FIG. 1B, like thin legs, struts, beams, walls, pillars, or other means of supporting the physical load of easel 120A or 120B. Easels 120A or 120B may use the writing surface bottom edge as a support, as illustrated, or comprise an entirely difference planform area and support system, like four legs and would therefore dispose writing surface a different angle than presented. Easel 120A-B writing surface may be adjustable in angle and in height to accommodate different users or applications. Easels 120A-B may comprise provisions for storage of supplies including, but not limited to, writing utensils, erasers, or the like. Easels 120A-B may comprise modular elements that may be removed and replaced with other modular furniture elements present or not within modular furniture system 100. Easels 120A-B, due to their large, flat writing surface, may or may not be disposed on the exterior of 3D form 104 in storage mode. This is only an example and does not preclude easels 120A-B to be folded, disassembled, or otherwise manipulated to fit within or on 3D form 104. Easels 120A-B may additionally include provisions for mobility such as rollers, wheels, casters, skis, treads, or the like disposed at the contact point of its support system to the ground.

Easels 120A-B may be configured to support significant physical loads in deployed and stored form. In deployed form, easels 120A-B may be rated to hold a certain amount of weight or mass on tabletop or each support system component given a certain safety margin as to not fail when used. Easels 120A-B may comprise external supports to assist in handling these loads like struts, beams, honeycombs, laminates, or other means one of ordinary skill in the art would appreciate to add strength to a physical thin and lightweight structure supporting loads in excess of its own weight, perhaps. Easels 120A-B may be similarly strong and tough in both tension and compression such that when deployed and stored, loads applied parallel to and transverse to members can be supported, for example while in shelf mode and 3D form 104 mode. Easels 120 A-B may comprise materials suitable for high-strength, low weight applications. These materials may comprise high-strength plastics like polypropylene, polycarbonate, polyethylene terephthalate, polyvinyl chloride (PVC), acrylonitrile butadiene styrene (ABS), high-density polyethylene (HDPE), nylon, and polystyrene, to name a few. Materials other than plastics may comprise high-strength, low-weight solutions like aluminum and aluminum alloys including magnesium, titanium, and beryllium alloys. Easels 120A-B may comprise fastening mechanisms and general mechanical coupling systems that are configured to couple easels to structural elements like bosses and channels, screws, bolts and nuts, nails, pins, dowels, rivets, and/or the like.

With continued reference to FIG. 1B, modular furniture system 100 may comprise chairs 124A-F. Chairs 124A-F may be all the same chair, configurable to be different chairs, or entirely different chairs than any of the rest found in modular furniture system 100, if multiple are present. There may be any number of chairs 124 present modular furniture system 100 as dictated by specific arrangement, design, and need, to name a few. Chairs 120A-F may comprise foldable designs configured to be stored in a flat storage mode, and extendable or expandable into a sitting mode, where students, for example, may sit on chairs 120A-F for use in modular furniture system 100. Chairs 120A-F may be extendable or expandable in a plurality of directions and therefore configurable for a plurality of desk heights, student heights, or storage orientations, for example. Though in the illustrative embodiment of FIG. 1B, six chairs are illustrated, in other embodiments modular furniture system 100 may include any number of chairs. Chairs 124A-F may hinge, fold, accordion, bend, disassemble, or otherwise change form between deployed and storage modes. Chairs 124A-F may also comprise interchangeable and modular components such that parts of chair 124A, for example, may be removed and replaced with similar or the same components from chair 124D. Chairs 124A-F may be stackable in deployed and/or storage form.

Chairs 124A-F may be configured to support significant physical loads in deployed and stored form. As the deployed chairs, chairs 124A-F may be rated to hold a certain amount of weight or mass on seat or each support system component given a certain safety margin as to not fail when used. Chairs 124A-F may comprise external supports to assist in handling these loads like struts, beams, honeycombs, laminates, or other means one of ordinary skill in the art would appreciate to add strength to a physical thin and lightweight structure supporting loads in excess of its own weight, perhaps. Chairs 124A-F may also comprise sacrificial components configured to fail first such that a user sitting on chair may be guarded from injury if chair were to fail. A sacrificial component is a component designed to fail before another more critical component fails or hinders chair failure in a manner detrimental to a user. For example, only, a pin in a chair's folding mechanism may fail and be easily replaced to save the more complicated hinge mechanism or to protect a user from having chair inadvertently fold during use. Chairs 124A-F may be similarly strong and tough in both tension and compression such that when deployed and stored, loads applied parallel to and transverse to members can be supported, for example while in chair mode and 3D form 104 mode. Chairs 124A-F may comprise materials suitable for high-strength, low weight applications. These materials may comprise high-strength plastics like polypropylene, polycarbonate, polyethylene terephthalate, polyvinyl chloride (PVC), acrylonitrile butadiene styrene (ABS), high-density polyethylene (HDPE), nylon, and polystyrene, to name a few. Materials other than plastics may comprise high-strength, low-weight solutions like aluminum and aluminum alloys including magnesium, titanium, and beryllium alloys. Chairs 124A-F may comprise fastening mechanisms and general mechanical coupling systems that are configured to couple chairs to structural elements like bosses and channels, screws, bolts and nuts, nails, pins, dowels, rivets, and/or the like. Chairs 124A-F may comprise elements configured to strengthen chairs at weak points, like the seat or thin areas, like for example, a folding point of chair.

With continued reference to FIG. 1B, modular furniture system 100 may comprise first aid kit 128. First aid kit 128 may comprise general minor injury care provisions. First aid kid 128 in no way should replace professional medical treatment and may only comprise supplies for emergency treatment, or minor aid for cuts, scrapes and injuries common to classrooms. First aid kit 128 may be configured to be stored within 3D form 104 and must at least in part be configured to encapsulate at least a portion of its constituent supplies in deployed and stored configurations. First aid kit 128 may comprise a box, as illustrated, a bag, or another storage method that can be easily accessed and stored with 3D form 104 or for use in modular furniture system 100.

First aid kit 128 may comprise, for example, gloves, bandages, gauze, antiseptic wipes, icepacks, gauze pads, gauze rolls, scissors, forceps, thermometers, medical tape, common anti-inflammatories, steroidal creams, antibiotic creams/ointments, sterile eye dressings, safety pins, insect repellant, antihistamines, cough medicine, eye washing solutions, emergency blankets, one-way breathing barrier, and absorbents, among other items. This is only an exemplary list, and one or ordinary skill in the art would appreciate a virtually unlimited combination of supplies that may be present in first aid kit 128.

First aid kit 128 may be configured to support significant physical loads in deployed and stored form. First aid kit 128 F may be rated to hold a certain amount of weight or mass on it given a certain safety margin as to not fail when used. First aid kit 128 may comprise external supports to assist in handling these loads like struts, beams, honeycombs, laminates, or other means one of ordinary skill in the art would appreciate to add strength to a physical thin and lightweight structure supporting loads in excess of its own weight, perhaps. First aid kit 128 may be similarly strong and tough in both tension and compression such that when deployed and stored, loads applied parallel to and transverse to members can be supported, for example while in chair mode and 3D form 104 mode. First aid kit 128 may comprise materials suitable for high-strength, low weight applications. These materials may comprise high-strength plastics like polypropylene, polycarbonate, polyethylene terephthalate, polyvinyl chloride (PVC), acrylonitrile butadiene styrene (ABS), high-density polyethylene (HDPE), nylon, and polystyrene, to name a few. Materials other than plastics may comprise high-strength, low-weight solutions like aluminum and aluminum alloys including magnesium, titanium, and beryllium alloys. First aid kit 128 may comprise fastening mechanisms and general mechanical coupling systems that are configured to couple easels to structural elements like bosses and channels, screws, bolts and nuts, nails, pins, dowels, rivets, and/or the like.

With continued reference to FIG. 1B, modular furniture system 100 may also comprise supply kit 132. Supply kit 132 may comprise a box or container of some kind configured to have at least a set of opposite and opposing sides and further configured to contain any components of modular furniture system 100 as discussed herein, such as supplies needed in a classroom setting. As illustrated in FIG. 1B, supply kit 132 may comprise a base of 3D form 104 and may also be manipulated, folded, disassembled, or in general reconfigured to be stored as 3D form 104. Supply kit 132 may comprise materials suitable for high-strength, low weight applications. One of ordinary skill in the art would appreciate the near limitless variation and combination of supplies, some of which may include, books, pens, pencils, notebooks, floor tiles, rugs, calculators, rulers, etc. supply kit 132 may comprise a shape that forms a portion of 3D form 104. Supply kit 132 may have every side of box enclosed with a removeable or reconfigurable cover, or at least an open side or more. These materials may comprise high-strength plastics like polypropylene, polycarbonate, polyethylene terephthalate, polyvinyl chloride (PVC), acrylonitrile butadiene styrene (ABS), high-density polyethylene (HDPE), nylon, and polystyrene, to name a few. Materials other than plastics may comprise high-strength, low-weight solutions like aluminum and aluminum alloys including magnesium, titanium, and beryllium alloys. Supply kit 132 may comprise fastening mechanisms and general mechanical coupling systems that are configured to couple easels to structural elements like bosses and channels, screws, bolts and nuts, nails, pins, dowels, rivets, and/or the like.

In embodiments, modular furniture elements 108A-128 may comprise photovoltaic cells configured to charge an energy storage system. An energy storage system, as used herein, may include a battery, battery pack, a battery module, a plurality of battery cells connected in series, in parallel, or a combination of series and parallel, a capacitor, a flywheel, or any combination thereof, to name a few. Batteries and/or battery cells may include, for example and without limitation, Li ion batteries (including NCA, NMC, Lithium iron phosphate (LiFePO4) and Lithium Manganese Oxide (LMO) batteries), nickel based batteries, lead-based batteries, metal-air batteries, or any other suitable battery. According to embodiments, photovoltaic cells can be disposed on a surface of one or more furniture elements 108A-128. For example, photovoltaic cells may be disposed in or on a flat surface of shelves 108A-B alone or in combination with other photovoltaic cells. In embodiments, photovoltaic cells may comprise electrical elements such as, for example, wires, cables, and/or conduits, configured to transfer electric current to an electrical energy storage device as described above. According to embodiments, the energy storage device may be configured to provide electrical energy to one or more components and/or electronic devices such as smartphones, computers, lights, fans, tablets, and the like, to name a few.

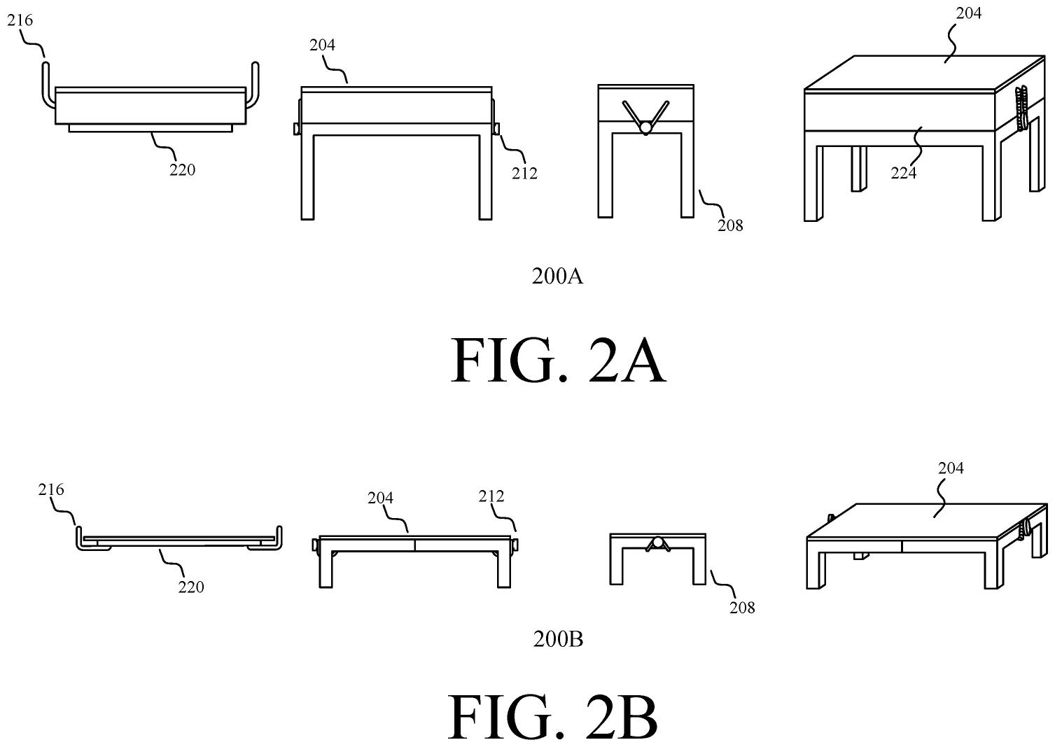

Referring now to FIG. 2A, an embodiment of modular furniture elements and a latching system thereof is presented, along with orthogonal projections of the same. Modular desk 200A is presented, according to in an embodiment. Modular desk 200A may comprise lid 204, frame 208, knob 212, rope 216, alignment feature 220, and container 224. Lid 204 may be aligned and secured to container 224 through a snap mechanism that will be discussed later in this paper. Lid 204 and container 224 are aligned and secured to frame 208 by alignment feature 220.

Frame 208 may comprise a support structure for holding desk 200A a certain height off the ground and configured for a student to write on lid 204 and store supplies within container 224. Frame 208 may have any shape and can comprise a number of legs disposed around frame 208. In embodiments, frame 208 can comprise first and second opposite and opposing sides (e.g. a top and a bottom side). Frame 208 may comprise an opening disposed on its topmost side configured to receive container 224.

Container 224 is configured to store one or more components and has a shape having opposite and opposing (e.g. top and bottom) sides. In embodiments, container 224 can include alignment feature 220 disposed on a first (e.g. bottom) side of container 224. Alignment feature 220 is captured, at least in part, by the opening in frame 208 and can comprise a boss, a channel, a flange, a track, or any combination thereof to name a few. In embodiments, when alignment feature 200 is received by frame 208, container 224 may be secured to frame 208 by a rope and knob mechanism. Frame 208 may comprise knob 212 disposed on a surface of frame 208. Knob 212 can include any shape and circumference and can further comprise a lip disposed on the circumference of a first end of knob. In embodiments, frame 208 may comprise more than one knob 212, for example illustrated with two in FIGS. 2A and B. Container 224 comprises rope 216 which is disposed on two ends of container 224 on two ends each configured in a loop. Each loop of rope 216 may be configured to surround a respective knob 212, at least in part, such that container 224 is secured to frame 208. Each loop of rope 216 may alternatively be removed from knob 208 and used as carrying handles to move container 224 and lid 204. Rope 216 may be secured to container 224 by through-holes and knots, clamps, adhesive, screws, nails, rivets, or the like. Frame 208 may comprise wood, plastics like polypropylene, polycarbonate, polyethylene terephthalate, polyvinyl chloride (PVC), acrylonitrile butadiene styrene (ABS), high-density polyethylene (HDPE), nylon, and polystyrene, to name a few. Materials other than plastics may comprise high-strength, low-weight solutions like aluminum and aluminum alloys including magnesium, titanium, and beryllium alloys. The same materials may be comprised by container 224, knob 208, and lid 204.

With continued reference to FIG. 2A and modular desk 200A, lid 204 may be a modular component and configured to be replaceable by another lid of a differing or similar function. Lid 204 may be removed and replaced with, for example, a transparent lid, a transparent lid with a light source (e.g. an LED, lightbulb, mirror, or any combination thereof) disposed underneath the lid such as for illuminating transparent pages or other activities (alternatively referred to as a “lightbox”), an activity mat, a lid with features that accept building blocks, a lid with blackboard material, a lid with whiteboard material, a lid with containers integral with it, and/or a lid with holes or openings, to name a few. desk 200A may be storable in the aforementioned 3D form in a plurality of arrangements, some of which have been discussed, and some that will be discussed later in this paper.

With reference now to FIG. 2B, and to modular stool 200B, a similar modular furniture element is presented. Modular stool 200B may be configured to support a person seated on a lid supported by a frame. Modular stool 200B may comprise lid 204, frame 208, knob 212, rope 216, and alignment feature 220. Modular stool 200B may comprise the same elements as modular desk 200A, except for, as an example, a container.

Modular stool 200B may comprise modular components that can be replaced with other components and may receive the same lid and frame as modular desk 200A. Modular stool 200B may comprise a similar or the same frame 208 as modular desk 200A with extendable or retractable legs or support systems. Rope 216 may be disposed on lid 204 in an exemplary embodiment. Frame 208 may comprise wood, plastics like polypropylene, polycarbonate, polyethylene terephthalate, polyvinyl chloride (PVC), acrylonitrile butadiene styrene (ABS), high-density polyethylene (HDPE), nylon, and polystyrene, to name a few. Materials other than plastics may comprise high-strength, low-weight solutions like aluminum and aluminum alloys including magnesium, titanium, and beryllium alloys. The same materials may be comprised by container 224, knob 208, and lid 204.

Referring now to FIG. 3, an isometric view of the disassembly of a modular furniture element for storage is presented. Modular desk 300, which may be the same as, or similar to, modular desk 200A may comprise desk 304, frame 308, frame top 312, frame supports 316, and stored frame 320. Desk 304 may comprise a container and lid as previously presented and that may be interchangeable. One of ordinary skill in the art would appreciate that any of the lids disclosed in this paper are further interchangeable with any other modular furniture elements disclosed here. As a non-limiting example, a desk lid may be interchangeable with a modular furniture element for a person to sit on, like a stool top. Desk 304 may comprise an alignment feature disposed on its underside to mate with frame top. Frame 308 may comprise members that are mechanically coupled together non-permanently and configured to be removed with no tools and with relative ease by a user. Frame 308 may be disassembled into frame top 312 and frame supports 316. Frame supports 316 may be secured in the opening of frame top 312 to form stored frame 320. Stored frame 320 may then be secured to desk 304 in some manner known to one of ordinary skill in the art after reading the entirety of this disclosure. Stored desk 324 is then formed and presented. Stored desk 324 may be the same or similar in construction and materials to any element of modular furniture discussed in the entirety of this paper. Note that latching mechanisms are not illustrated in this figure but may be present in embodiments. Stored desk 324 may be further configured to be stored in a 3D form similar to, or the same as, 3D form 104 with a plurality of other modular furniture elements.

With continued reference to FIG. 3, frame supports 316 may temporarily mechanically couple to frame top 312 using any of the above described mechanical coupling methods, alone or in combination, as well as any other undisclosed method, alone or in combination. Alternatively, frame supports 316 may not necessarily decouple from frame top 312 but swing, rotate, pull, or otherwise move to their storage position. Additionally, stored frame 320 may not necessarily take the form that is illustrated in FIG. 3. As illustrated, frame supports 316 moves to the negative open space within frame top 312 that normally accepts a modular furniture element. Frame supports 316 may be mechanically coupled to frame top 312 members or be stored in another modular furniture element for further storage in 3D form.

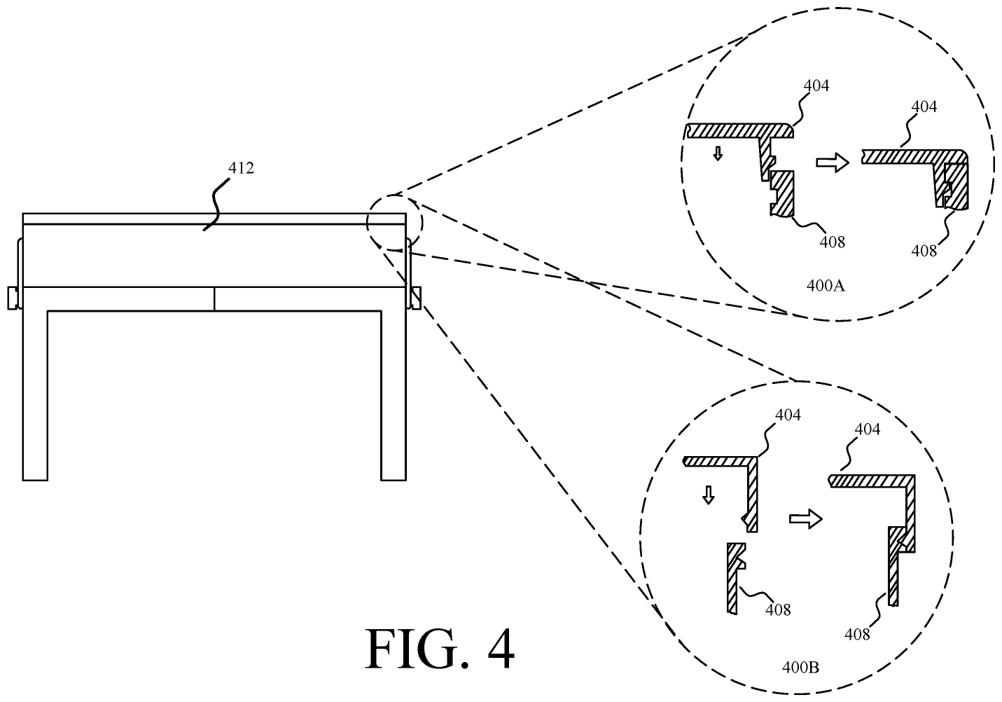

Referring now to FIG. 4, cutaway views of embodiments of snap fit mechanisms are presented for securing a lid in a modular furniture element 412. Illustrative embodiments of snap-fit mechanisms 400A and 400B comprise a protrusion 404 and receptacle 408. Snap fit mechanism 400A comprises an internal snap fit. That is to say a first modular furniture element, which comprises protrusion 404 disposed on its underside around at least a portion of the perimeter of a first modular furniture element may be pushed down onto a second modular furniture element which may comprise receptacle 408 disposed around at least a portion of its perimeter that mates with protrusion 404. During its path downward, protrusion 404 is deflected by the first portion of receptacle 408, and then returns to its original position and is captured by receptacle 408, arresting its motion. To remove protrusion 404 from receptacle 408, a user needs to deflect protrusion out of receptacle 408 and move the first modular furniture element up and out. External snap fit mechanism 400B comprises the same physical principles of 400A, except, in an exemplary embodiment, protrusion 404 and receptacle 408 are disposed on the exterior of modular furniture elements, around the perimeter of a first and second thereof. Snap fit mechanism 400A or 400B may be disposed in or on a plurality of modular furniture elements, similar to 412 or otherwise, configured to allow two or more modular furniture elements to be mechanically coupled together. Snap fit mechanism rely on a material's ability to elastically deform (change shape temporarily) and return to its original shape. Materials with this ability that can be deflected over and over again and return to their original shape may be elastomers, polymers like isoprene, neoprene, synthetics like 2-chloro-1, 3-butadiene and the like, to name a few. Certain plastics and even metals and alloys can perform this elastic deformation function, some of which have been named in this paper and which one of ordinary skill in the art would appreciate.

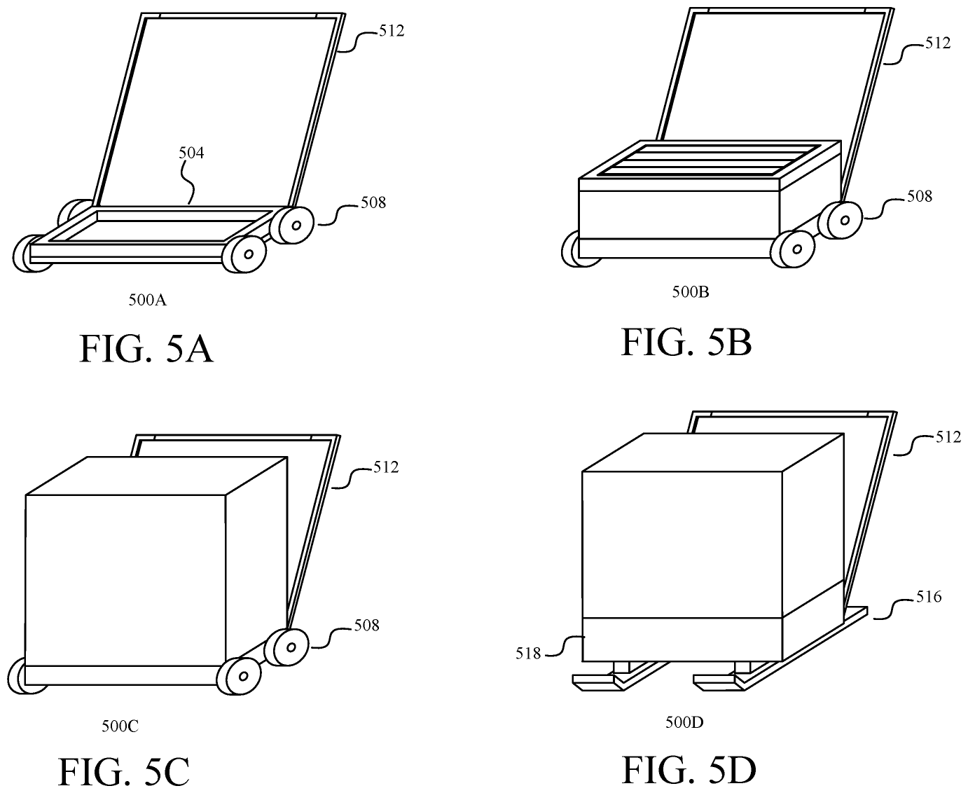

Referring now to FIGS. 5A-D, transportation systems 500A-D are presented, in embodiments. Transportation systems 500A-D may be configured to assist a user in moving at least a portion of modular furniture system 100, 3D form, or a combination thereof from one physical location to another. Referring now to FIG. 5A, a transportation system for modular furniture elements is presented. Transportation system 500A comprises a base frame 504 configured to accept a modular furniture element, especially a modular furniture element including an alignment feature presented in previous figures. Transportation system 500A may also comprise wheels 508 and handle 512. With reference to FIG. 5B, a transportation system for modular furniture elements is presented. Transportation system 500B may secure and retain modular furniture elements and/or be configured to accept 3D form similar to, or the same as 3D form 104 as presented in 500C with reference to FIG. 5C. Additionally or alternatively, with reference to FIG. 4D, transportation system 500D may comprise different components that allow movement of a heavy object like 3D form 104 with skis 516.

Referring again to FIGS. 5A-C, wheels 508 may be disposed on the lateral sides of base frame 504 at parallel and symmetric attachment points. Transportation systems 500A-C are illustrated with four wheels, but other embodiments may have more or less, or even unsymmetrical disposition of said wheels, like a wheelbarrow, in which one wheel is disposed along the center line and a user balances load on the one wheel during transportation.

Referring again to FIG. 5D, transportation system 500D may comprise skis 516 on the underside of base frame 504. Skis 516 may allow heavy loads to be more easily moved over terrain by lessening the amount of friction experienced by lessening the surface area the load is generating friction from. Skis 516 may be comprised in an exemplary embodiment and are more effective in a first direction than a plurality of directions. Caster wheels, which are characterized by wheels on an axle that are mechanically coupled on the underside of an exemplary transportation system, comprise a mechanical coupling configured to allow the axle of the wheel to rotate, thus changing the direction in which the wheel spins relative to the transportation system itself. Any of transportation systems 500A-D illustrated in FIGS. 5A-D, may comprise storage container 518. Storage container 518 may be configured to store modular furniture elements, components, or other room materials. Storage container 518 may be integral to transportation system 500A-D or temporarily mechanically coupled to said transportation system 500A-D. One of ordinary skill in the art would understand that any of the illustrative embodiments presented in FIGS. 5A-D may comprise storage container 518, and that storage container 518 may comprise elements to secure modular furniture elements. Additionally, storage container 518 may comprise a plurality of forms, some of which may include a box with a lid or an open box comprising four walls and a floor. Storage container 518 may be disposed under modular furniture elements relative to transportation system 500A-D, or at another undisclosed orientation relative to transportation system 500A-D.

Transportation systems 500A-D may have simple machines or combinations of simple machines to aid in the loading of a load onto base frame like a wedge. In this exemplary embodiment, transportation system 500A-D may have a ramp disposed on the front end so a user may push handle 512 such that a load is scooped up by transportation system 500A-D in one motion. Handle 512 may be disposed at the rear of transportation system 500A-D and extend upwards at a plurality of angles to a user's hand height. Handle 512 may comprise adjustable components that may, for example, change the angle at which handle 512 rises from base frame 504 and/or change the length of handle 512's arms that extend upwards. Transportation systems 500A-D may be constructed from high strength materials where high loads are experienced, like the axles of wheels or struts of skis, base frame 504, and/or the mechanical coupling of handle 512 to base frame 504, and therefore employ materials like aluminum and aluminum alloys, a plurality steel alloys, titanium and titanium alloys, high-strength plastics like polypropylene, polycarbonate, polyethylene terephthalate, polyvinyl chloride (PVC), acrylonitrile butadiene styrene (ABS), high-density polyethylene (HDPE), nylon, polystyrene, fiberglass, carbon fiber reinforced plastic, carbon reinforced carbon (carbon-carbon), and composites, amongst others, to name a few.

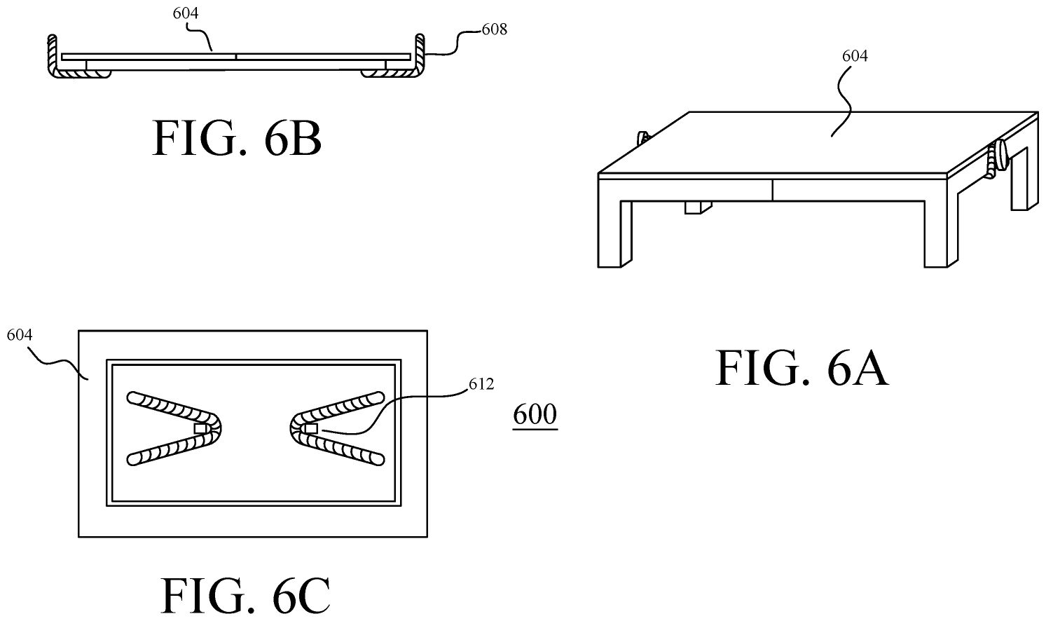

Referring now to FIG. 6A, an isometric view of modular furniture is presented. Rope retainment system 600 may be disposed on a modular furniture element 604, which may be similar or the same as any modular furniture element like a lid and is configured to secure at least a portion of one modular furniture element to at least a portion of a second modular furniture element.

Referring to FIGS. 6B and 6C, rope retainment system 600 comprises modular furniture element 604, rope 608, and rope retainment feature 612. Rope retainment feature 612 may be configured to temporarily mechanically couple rope to modular furniture element while not being used for securing to another element of modular furniture and comprise a boss, channel, hook, clamp, loop, or other undisclosed mechanical system disposed on or in modular furniture element 604. Rope retainment feature 612 may be constructed of the same materials as modular furniture element 604. These materials may comprise materials suitable for high-strength, low weight applications. These materials may comprise high-strength plastics like polypropylene, polycarbonate, polyethylene terephthalate, polyvinyl chloride (PVC), acrylonitrile butadiene styrene (ABS), high-density polyethylene (HDPE), nylon, and polystyrene, to name a few. Materials other than plastics may comprise high-strength, low-weight solutions like aluminum and aluminum alloys including magnesium, titanium, and beryllium alloys.

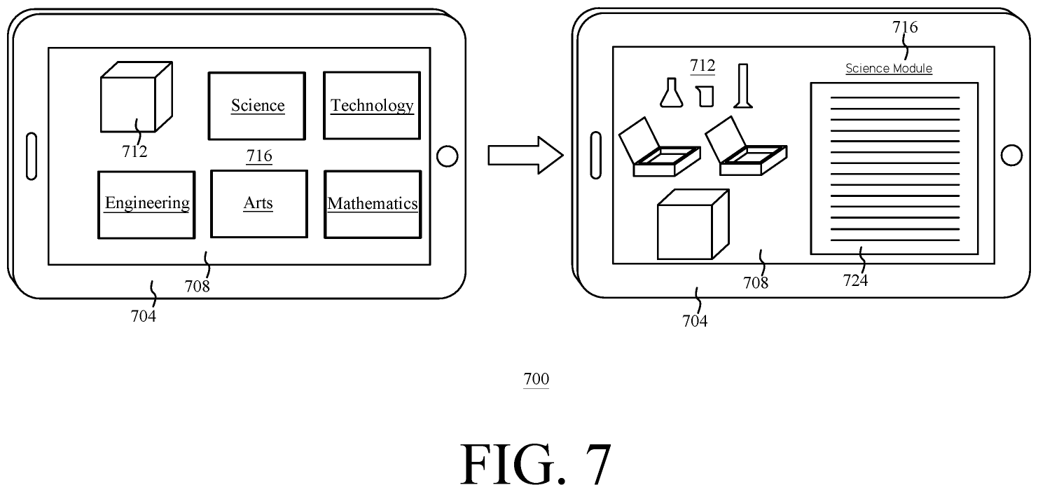

Referring now to FIG. 7, electronic web application 700 that works in tandem with modular furniture is presented. A client device 704 may comprise a graphical user interface (GUI) 708 that presents information associated with modular furniture elements 712. In embodiments, GUI 708 may be displayed on a client device 704 such as a smartphone, tablet, laptop, computer, or any combination thereof. GUI 708 can be operated on a computing device and can be configured to display information relating to modular furniture elements 712 such as the quantity of modular furniture elements, arrangement of the modular furniture elements for storage, videos related to the predetermined application, software related to the predetermined application, or any combination thereof—to name a few. According to embodiments, GUI 708 can be configured to receive user inputs as interactions with a touchscreen, keyboard, mouse, touchpad, or any combination thereof. According to the received interactions, GUI 708 may be configured to render and display information related to modular furniture elements 712 such as, for example, instructions for the arrangement of the modular furniture elements for storage. Electronic web application may be a software downloadable by any device of the plurality of devices as described in the entirety of this disclosure.

Still referring to FIG. 7, electronic web application 700 includes learning modules 716 operating on the server. Learning modules 716 may include any suitable software and/or hardware as described in the entirety of this disclosure. In an embodiment, electronic web application 700 is designed and configured to receive a lesson selection from client device 704 and transmit a plurality of lesson modules to client device 704 as a function of the lesson selection. Learning modules 716 is further configured to receive at least a user interaction datum from client device 704 and recording a module progression datum for each lesson module of the plurality of lesson modules as a function of the at least a user interaction datum. The “plurality of lesson modules” as described in the entirety of this disclosure, is a collection of data correlated to each course of the plurality of courses available on any of a plurality of servers. Each course of the plurality of courses may include, for example and without limitation, foundational knowledge, such as definitions, classifications, history, information, science, technology, engineering, mathematics, art, a combination thereof, and the like. Persons skilled in the art, upon reviewing the entirety of this disclosure, will be aware of various methods of organizing lessons and progressing through modules in a virtual classroom environment, among other applications.

Electronic web application 700 may include any suitable software and/or hardware module as described in the entirety of this disclosure. In an embodiment, electronic web application 700 may be configured to receive a lesson selection of learning modules 716 from client device 704. The “lesson selection” as used in the entirety of this disclosure, is the learning module of the plurality of learning modules client device 704 has selected to engage with. The learning module 716 may include any learning module 716 as described in the entirety of this disclosure. Lesson selection may include a lesson and/or sub-topic of the coursework available at the time. Receiving a learning module selection from client device 704 may include selecting a learning module from a menu of the plurality of learning modules 716, a list, a visual display, and the like. Learning module selection may include, as an example and without limitation, the learning module next to complete in the lesson plan or curriculum. As a further example and without limitation, learning module selection may include the learning module of the plurality of learning modules that the user device was engaged with on the last authenticated use of the system.

With continued reference to FIG. 7, electronic web application 700 may be configured to transmit a plurality of learning modules 716 from a training database to client device 704 as a function of learning module selection. Electronic web application 700 may include or communicate with a training database. The training database may be implemented as any database and/or datastore suitable for use as training database as described in the entirety of this disclosure. Plurality of learning modules 716 are a collection of data correlated to each course of the plurality of courses associated with one or more STEAM topics. Each course of the plurality of courses may include, for example and without limitation, foundational knowledge, such as definitions, classifications, information, science, technology, engineering, art, or mathematics, and the like. Additionally, in embodiments, learning modules may target one or more key development areas including, but not limited to: cognitive skills, aesthetic expression and creative skills, numeracy skills, motor skills, social and emotional skills, and literacy skills, or any combination thereof. Each learning module of the plurality of learning modules 716 may include assessments and activities to be completed by the user or students utilizing client device 704. Each learning module 716 may be designed to enable the user of client device 704 to become proficient at each course of the plurality of courses associated with one or more STEAM topics.

Still referring to FIG. 7, electronic web application 700 may be further configured to receive at least a user interaction datum from client device 704. The user interaction datum is configured to correlate to each learning module of the plurality of learning modules 716, such that the user interaction datum includes the latest interactions of user and client device 112, including the data associated with the interaction. The user interaction datum may include, for example and without limitation, a user interaction with a reading, activity, assessment, and the like. The interaction datum may include a set of answers for an assessment, a typographical entry correlating to an answer to a question, a video response, any combination thereof, and/or the like. The latest received user interaction datum is configured to correlate to the position of the user and/or client device 704 within the plurality of learning modules 716. Persons skilled in the art, upon reviewing the entirety of this disclosure, will be aware of various inputs that may represent the user interaction datum consistently with this disclosure.

Continuing to refer to FIG. 7, electronic web application 700 operating on a server may be further configured to record a module progression datum for client device 704 in a training database for each learning module of the plurality of learning modules 716 as a function of the user device interaction datum. The “module progression datum” as described in the entirety of this disclosure, is the furthest point of progress of client device 704 of the plurality of modules for each authenticated use of client device 704 in electronic web application 700, including the data associated. The module progression datum may include, for example and without limitation, client device 704 halfway through an assignment of a learning module of the plurality of learning modules 716, such that three user interaction datum have been received from client device 704, however the learning module is not complete until client device 704 records module progression datum, detailing the progress of the user and/or client device 704, in a training database. As a further example and without limitation, module progression datum may include client device 704 repeatedly failing a learning module, course, or the like. Persons skilled in the art, upon reviewing the entirety of this disclosure, will be aware of various datums that may represent the module progression datum consistently with this disclosure.

Still referring to FIG. 7, one or more database tables in a training database may include, as a non-limiting example, a learning module datum table. A learning module datum table may be a table storing the plurality of learning modules 716 and/or matching the plurality of learning modules to the learning module selection from client device 704. For instance, and without limitation, a training database may include a learning module datum table listing each learning module of the plurality of learning modules 716, the associated data of each learning module, such as assignments, readings, assessments, and the like, and the user interaction datum.

Continuing to refer to FIG. 7, one or more database tables in the training database may include, as a non-limiting example, a module progression datum table. A module progression datum table may be a table storing module progression datum and/or associating learning module selection to the stored module progression datum. For instance, and without limitation, the training database may include a module progression datum table listing module progression datum correlated to each lesson module of the plurality of lesson modules. Tables presented above are presented for exemplary purposes only; persons skilled in the art will be aware of various ways in which data may be organized in the training database consistently with this disclosure.

With continued reference to FIG. 7, learning modules 716 may be displayed for interaction and selection. As stated before, GUI 708 may be configured to receive user inputs as interactions with a touchscreen, keyboard, mouse, touchpad, or any combination thereof to select learning modules 716. Once selected, learning modules 716 may display the contents of the physical learning module boxes present within modular furniture system 100, instructions to set up classroom, in embodiments, and present material 724 corresponding to learning module 716 that was selected. Material 724 may include slide decks, videos, documents, and pictures, among others, to name a few. Material 724 may be periodically updated based on certain amounts of time, when objectives are completed, when activities are completed, and the like. Access to online services like material 724 provided may be a paid subscription service, a free subscription service, an online library of content, or a similar or undisclosed system of storing electronic information. Material 724 may be automatedly updated based on physical learning modules present with modular furniture system 100 or may be selected at a preceding point in GUI 708 to material 724. Electronic web application 700 and client 704 may be provided with modular furniture system 100. Alternatively, a user could be provided modular furniture elements 712 and use a previously owned client device 704 and access electronic web application and material 724 through an electronic communicative coupling. Communicative coupling may be a wired or wireless connection that may employ electronic buses, ethernet, internet, WiFi, Bluetooth, cellular network, or another undisclosed method alone or in combination. Additionally, or alternatively, client device 704 be communicatively coupled to a first server. This communicative coupling, as disclosed, is a connection sufficient for transferring data between client device 704 and a first server including WiFi, ethernet, cellular networks, Bluetooth, NB-IoT, LTE CAT1, LTE-M1, CAT NB1, long-range (LoRA) communication connects, or any combination thereof, to name a few.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

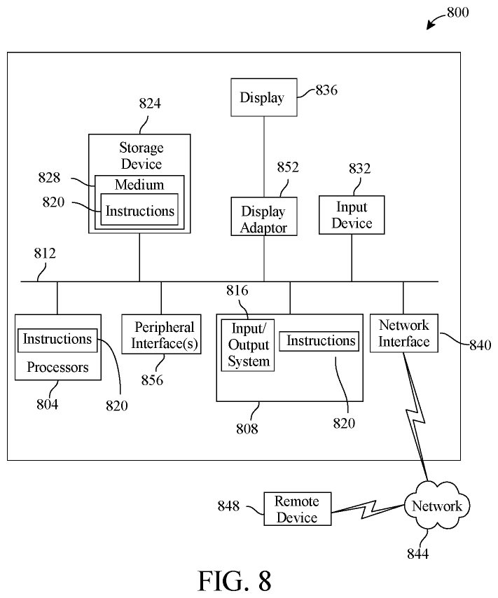

FIG. 8 shows a diagrammatic representation of one embodiment of a computing device in the exemplary form of a computer system 800 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 800 includes a processor 804 and a memory 808 that communicate with each other, and with other components, via a bus 812. Bus 812 may include any of several types of bus structures including, but not limited to, a memory bus, a memory controller, a peripheral bus, a local bus, and any combinations thereof, using any of a variety of bus architectures.

Memory 808 may include various components (e.g., machine-readable media) including, but not limited to, a random-access memory component, a read only component, and any combinations thereof. In one example, a basic input/output system 816 (BIOS), including basic routines that help to transfer information between elements within computer system 800, such as during start-up, may be stored in memory 808. Memory 808 may also include (e.g., stored on one or more machine-readable media) instructions (e.g., software) 820 embodying any one or more of the aspects and/or methodologies of the present disclosure. In another example, memory 808 may further include any number of program modules including, but not limited to, an operating system, one or more application programs, other program modules, program data, and any combinations thereof.

Computer system 800 may also include a storage device 824. Examples of a storage device (e.g., storage device 824) include, but are not limited to, a hard disk drive, a magnetic disk drive, an optical disc drive in combination with an optical medium, a solid-state memory device, and any combinations thereof. Storage device 824 may be connected to bus 812 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 824 (or one or more components thereof) may be removably interfaced with computer system 800 (e.g., via an external port connector (not shown)). Particularly, storage device 824 and an associated machine-readable medium 828 may provide nonvolatile and/or volatile storage of machine-readable instructions, data structures, program modules, and/or other data for computer system 800. In one example, software 820 may reside, completely or partially, within machine-readable medium 828. In another example, software 820 may reside, completely or partially, within processor 804.

Computer system 800 may also include an input device 832. In one example, a user of computer system 800 may enter commands and/or other information into computer system 800 via input device 832. Examples of an input device 832 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 832 may be interfaced to bus 812 via any of a variety of interfaces (not shown) including, but not limited to, a serial interface, a parallel interface, a game port, a USB interface, a FIREWIRE interface, a direct interface to bus 812, and any combinations thereof. Input device 832 may include a touch screen interface that may be a part of or separate from display 836, discussed further below. Input device 832 may be utilized as a user selection device for selecting one or more graphical representations in a graphical interface as described above.

A user may also input commands and/or other information to computer system 800 via storage device 824 (e.g., a removable disk drive, a flash drive, etc.) and/or network interface device 840. A network interface device, such as network interface device 840, may be utilized for connecting computer system 800 to one or more of a variety of networks, such as network 844, and one or more remote devices 848 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 844, may employ a wired and/or a wireless mode of communication. In general, any network topology may be used. Information (e.g., data, software 820, etc.) may be communicated to and/or from computer system 800 via network interface device 840.

Computer system 800 may further include a video display adapter 852 for communicating a displayable image to a display device, such as display device 836. Examples of a display device include, but are not limited to, a liquid crystal display (LCD), a cathode ray tube (CRT), a plasma display, a light emitting diode (LED) display, and any combinations thereof. Display adapter 852 and display device 836 may be utilized in combination with processor 804 to provide graphical representations of aspects of the present disclosure. In addition to a display device, computer system 800 may include one or more other peripheral output devices including, but not limited to, an audio speaker, a printer, and any combinations thereof. Such peripheral output devices may be connected to bus 812 via a peripheral interface 856. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve embodiments according to this disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A system for modular furniture storage and deployment, wherein the system comprises:
a three-dimensional form having opposite, opposing sides; and
a plurality of modular furniture elements each configurable from a storage mode to a deployed mode;
wherein the three-dimension form is configured to encapsulate a modular furniture element in a storage mode;
wherein each of the plurality of modular furniture element are further configured to couple to at least one other of the plurality of furniture elements; and wherein two coupled modular furniture elements form at least a portion of a side of the three-dimensional form.

2. The system of claim 1, wherein the three-dimensional form comprises a cube.

3. The system of claim 2, wherein each length of the cube is 1 meter.

4. The system of claim 1, further comprising a graphical user interface displaying information associated with the plurality of modular furniture elements.

5. The system of claim 1, wherein the plurality of modular furniture elements comprises a plurality of classroom furniture elements.

6. The system of claim 1, wherein the plurality of modular furniture elements comprises at least one selected from a group of a table, an easel, a whiteboard, a stool, or a box.

7. The system of claim 1, wherein the plurality of modular furniture elements comprises a first and second table.

8. The system of claim 7, wherein at least a portion of the first table and at least a portion of the second table are configured to form a surface of the three-dimensional form when coupled.

9. The system of claim 1, wherein at least a client device communicates electronically with at least a remotely located server.

10. The system of claim 1, wherein a first modular furniture element of the plurality of modular furniture elements comprises a rope disposed on the first modular furniture element and a second modular furniture element of the plurality of modular furniture elements comprises a knob configured to secure the first modular furniture element to the second modular furniture element by the rope.

11. The system of claim 1, wherein a modular furniture element of the plurality of modular furniture elements may comprise one selected from a group of a rolling element and a sliding element.

12. The system of claim 1, wherein a modular furniture element of the plurality of modular furniture elements may be configured to store in a flat configuration.

13. The system of claim 1, wherein a modular furniture of the plurality of modular furniture elements may be stored in a three-dimensional form.

14. The system of claim 1, wherein a modular furniture element of the plurality of modular furniture elements may be mechanically couplable to any other element of modular furniture.

15. The system of claim 1, wherein a modular furniture element of the plurality of modular furniture elements may comprise an energy charging and storage system.

16. The system of claim 15, wherein the energy charging and storage system may further comprise photovoltaic cells.

17. The system of claim 1, wherein a first element of modular furniture of the plurality of modular furniture elements may comprise a snap fit mechanical coupling configured to couple with a second element of modular furniture of the plurality of modular furniture elements.

18. The system of claim 1, wherein the modular furniture elements and three-dimensional form may be configured to support mechanical loads in deployed and storage forms.

19. The system of claim 1, wherein the modular furniture elements that three-dimensional form comprises may be configurable to include different combinations of modular furniture elements.
